(19) United States
(12) Patent Application Publication
(10) Pub. No.: US 2025/0196229 A1
(43) Pub. Date: Jun. 19, 2025

(54) A METHOD AND APPARATUS FOR DETERMINING A MODE OF MELT POOL FORMATION

(71) Applicant: RENISHAW PLC, Wotton-under-Edge, Gloucestershire (GB)

(72) Inventors: Andrew John MOORE, Riccarton (GB); loannis BITHARAS, Riccarton (GB)

(73) Assignee: RENISHAW PLC, Wotton-under-Edge, Gloucestershire (GB)

(21) Appl. No.: 18/847,981

(22) PCT Filed: Mar. 17, 2022
(86) PCT No.: PCT/GB2022/050677

§ 371 Date: Sep. 17, 2024

(51) Int. Cl. B22F 10/80; B22F 10/28; B22F 12/90; B33Y 50/00

(52) U.S. Cl. CPC B22F 10/80; B22F 10/28; B22F 12/90; B33Y 50/00

(57) ABSTRACT

A monitoring method for monitoring a melting process including receiving sensor values captured with a sensor system measuring a property of a plasma plume generated during formation of a melt pool with an energy beam; and determining a measure of turbulence in the plasma plume from the sensor values. A monitoring method may include determining a melt pool formation stage from whether the measure of turbulence is above or below a threshold value.

### FIELD OF INVENTION

This invention concerns a method and apparatus for determining a mode of melt pool formation. The invention has particular, but not exclusive application, to a method for determining a mode of melt pool formation in an additive manufacturing apparatus, such as a powder bed fusion apparatus, and apparatus to carry out the method. The method may comprise controlling the apparatus in response to determination(s) of the melt pool mode during the or a previous additive manufacturing process.

### BACKGROUND

In laser powder bed fusion, a powder layer is deposited on a powder bed in a build chamber and a laser beam is scanned across portions of the powder layer that correspond to a cross-section (slice) of the workpiece being constructed. The laser beam melts the powder to form a solidified layer. After selective solidification of a layer, the powder bed is lowered by a thickness of the newly solidified layer and a further layer of powder is spread over the surface and solidified, as required. In a single build, more than one part can be built, the parts spaced apart in the powder bed. It is known to melt the powder layer simultaneously with more than one laser.

Owing to the high energy required for processing, the laser-material interaction results in rapid melting and evaporation of the metal substrate and powder. This results in a complex, dynamic process where selection and/or control of a large number of variables is required for the production of successful parts. Typically, laser exposure parameters, such as scan speed, laser power, hatch spacing and spot size are selected before the build for different regions of a part (such as bulk and overhang regions) and the build is carried out according to those pre-selected exposure parameters. A problem with such a control regime is that such parameters may not be appropriate for all part geometries and over or under-exposure of regions of the part can still occur, resulting in under-desirable results, such as porosity.

During powder bed fusion different melt pool formation mechanisms may occur, normally categorised into conduction mode, transition mode and keyhole mode. In each mode, the melt pool has a different melt pool morphology. In conduction mode energy of the energy beam is coupled into the powder bed primarily through heat conduction creating a melt pool having a width equal to or greater than twice its depth (a ratio of depth to width of less than 0.5). This is to be contrasted with keyhole mode in which a hole is formed in the melt pool where material is vaporised by exposure to the energy beam. A melt pool formed in keyhole mode has a deep, narrow profile with a ratio of depth to width of greater than 1.5. A transition mode exists between the conduction mode and the keyhole mode, wherein the energy does not dissipate quickly enough, and the processing temperature rises above the vaporisation temperature. A depth of the melt pool increases, and penetration of the melt pool can start.

When melting in powder bed fusion it is often desirable to form the melt pools within one or two of these modes. In particular, the applicant has found that there are advantages to maintaining melt pool formation in the conduction and/or transition modes. Melt pool formation in the keyhole mode tends to result in the formation of pores as a result of sporadic collapse of the keyhole and solidification cracking in difficult to process materials. It would therefore be desirable to determine a mode of melt pool formation during powder bed fusion in order to check that melt pools with a required melt pool morphology are being formed.

### SUMMARY OF INVENTION

According to a first aspect of the invention there is provided a monitoring method for monitoring a melting process comprising receiving sensor values captured with a sensor system measuring a property of a plasma plume generated during formation of a melt pool with an energy beam; and determining a measure of turbulence in the plasma plume from the sensor values.

It has been found that there is a correlation between turbulence in the plasma plume generated during melt pool formation and a formation mode or state of the melt pool. Thus, the measure of turbulence in the plasma plume provides an indication or measure of the melt pool formation mechanism, such as stable melting and the formation of the initial surface depression (stage I), its transition into a metastable state, where the liquid-vapour interface is perturbed but its shape recovers (stage II) and unstable melting and plume due to a continuously fluctuating keyhole (stage III). These modes or stages may closely correspond to the traditional categorisation into conduction (stage I), transition (stage II) and keyhole modes (stage III). Accordingly, a mode of melt pool formation mechanism can be determined for a melt pool obscured by a powder bed and/or a substrate within which the melt pool is formed from measuring properties of a plasma plume generated above the powder bed and/or substrate.

The method may comprise determining from the measure of turbulence whether melt pool formation occurred in either i) one of stage I (conduction mode) and stage II (transition mode), or ii) stage III (keyhole mode). It has been found that the transition of the melt pool from stage I to stage III is accompanied by a step change in turbulence in the accompanying plasma plume. In particular, in experiments, the transition of the melt pool from stage I to stage III was accompanied by a transition from laminar to turbulent flow in the accompanying plasma plume. Accordingly, determining a melt pool formation stage may comprise determining whether the measure of turbulence is above or below a threshold value used to demarcate between different melt pool formation stages. The threshold value may correspond to a laser input energy density of around 70 GJ/m³, for example, 60 GJ/m³ to 80 GJ/m³, preferably 65 GJ/m³ to 75 GJ/m³ and more preferably, 69 GJ/m³ and 71 GJ/m³. The threshold value may correspond to a front wall angle of the melt pool of about 70°, for example a front wall angle of 65° to 75°.

The method may comprise determining from the measure of turbulence a melt pool morphology. The melt pool morphology may be a shape of the melt pool below a surface of the melt pool. In stage I the melt pool may have a width equal to or greater than twice its depth (a ratio of depth to width of less than 0.5). In stage III the melt pool may have a ratio of depth to width of greater than 1.5. In stage II the melt pool may have a ratio of depth to width of between 0.5 and 1.5. The method may comprise determining from the measure of turbulence whether the melt pool has a ratio of depth to width of greater or less than 1.5. The melt pool morphology may be to a front wall angle, for example a front wall angle of greater than 65°, and more preferably, greater than 70°.

The method may comprise estimating a melt pool depth from the measure of turbulence.

The measure of turbulence may be a measure quantifying instability in the plasma plume over a time period during formation of the melt pool. The measure of turbulence may be determined from sensor values captured at different times during melt pool formation, such as a difference in the sensor values captured at the different times.

The sensor system may comprise a visible light and/or infra-red sensor for detecting visible light and/or infra-red light generated by the plasma plume. The property measured by the sensor system may be variations in refractive index of the plasma plume.

According to a second aspect of the invention there is provided a monitoring method for monitoring a melting process comprising receiving sensor values captured with a sensor system measuring a refractive index of a plasma plume generated during formation of a melt pool with an energy beam, the sensor values captured at different times during melt pool formation; and determining a difference in the refractive index measured at the different times from the sensor values.

The measure of turbulence determined in the first aspect of the invention may be determined from the difference determined in accordance with the second aspect of the invention.

The sensor may comprise an imaging sensor and the sensor values may be images of the plasma plume. The measure of turbulence may be determined from image processing, such as an intensity difference in pixel values of images captured of the plasma plume at the different times. The measure of turbulence may be determined by summing the differences in corresponding pixels of images captured at the different times. The summed difference may give a measure of the turbulence in the plasma plume between these different times.

The image may be an image representing variations in refractive index within the plasma plume caused by density gradients within the plasma. The image of the plasma plume may be captured using schlieren imaging.

The method may comprise receiving sets of sensor values captured with a plurality of sensors of the sensor system, each sensor measuring a property of the plasma plume generated with the energy beam and each set of sensor values captured by a different one of the sensors, and determining from at least one of the sets of sensor values a measure of turbulence in the plasma plume and/or the difference in the refractive index measured at the different times. In a melting process, such as a multi-energy beam melting process, more than one melt pool, and thus more than one plasma plume, may be formed simultaneously. A plasma plume generated by one melt pool may block a sensor from viewing plasma plumes of one or more other melt pools. By using a plurality of sensors, the chance that a plasma plume is obscured from every sensor is reduced.

According to a third aspect of the invention there is provided a monitoring method for monitoring a melting process comprising receiving a measure of turbulence in a plasma plume generated during formation of a melt pool with an energy beam; and determining from the measure of turbulence whether melt pool formation occurred in either i) one of stage I (conduction mode) and stage II (transition mode), or ii) stage III (keyhole mode).

The measure of turbulence may be determined using the monitoring method of the first aspect of the invention.

The monitoring method of the first, second and/or third aspects of the invention may comprise carrying out an action in response to the measure of turbulence, the difference in the refractive index measured at the different times and/or determined stage of melt pool formation. For example, the action may comprise controlling the melting process (feedback system). The action may comprise controlling a further melting process, such as a further melting process in manufacture of the same object or manufacture of another object (a feed-forward system). Controlling the melting process or the further melting process may comprise controlling exposure parameters of the energy beam. The melting process or further melting process may be controlled to achieve melt pool formation in a desired stage (stage I/II or stage III).

The action may comprise visualising the determined turbulence, difference in the refractive index measured at the different times and/or stage of melt pool formation at corresponding locations on a representation of a part produced by the melting process. Accordingly, the determined turbulence, difference in the refractive index measured at the different times and/or stage of melt pool formation may be visualised in a two- or three-dimensional representation.

The action may comprise the generation of an alert when the determined turbulence, difference in the refractive index measured at the different times and/or stage of melt pool formation fall outside predetermined threshold values.

The method may comprise associating each determined turbulence, difference in the refractive index measured at the different times and/or stage of melt pool formation with a corresponding coordinate location. For example, the coordinate location may be derived from demand signals sent to a scanner for scanning the energy beam or measured positions of guiding elements, such as steerable mirrors, for steering the energy beam to a desired location, as is disclosed in WO2018/087556, which is incorporated herein in its entirety by reference.

The method may comprise forming the melt pool with the energy beam and capturing the sensor values with the sensor system during formation of the melt pool. The energy beam may be a laser beam or an electron-beam.

The method may be carried out by a processing unit of a computer.

According to a fourth aspect of the invention there is provided a computer analyser arranged to carry out the monitoring method of the first aspect, second aspect and/or third aspect of the invention.

According to a fifth aspect of the invention there is a provided a data carrier having instructions stored thereon, the instructions, when executed by a processor causing the processor to carry out the monitoring method of the first aspect, second aspect and/or third aspect of the invention.

The data carrier may be a suitable medium for providing a machine with instructions such as non-transient data carrier, for example a floppy disk, a CD ROM, a DVD ROM/RAM (including −R/−RW and +R/+RW), an HD DVD, a Blu Ray™ disc, a memory (such as a Memory Stick™, an SD card, a compact flash card, or the like), a disc drive (such as a hard disc drive), a tape, any magneto/optical storage, or a transient data carrier, such as a signal on a wire or fibre optic or a wireless signal, for example signals sent over a wired or wireless network (such as an Internet download, an FTP transfer, or the like).

According to a sixth aspect of the invention there is provided energy beam melting apparatus comprising an irradiation device, such as a scanner, for directing an energy beam to a powder bed or substrate to melt the powder or substrate and a sensor system arranged to measure variations in a refractive index of a plasma plume generated during formation of a melt pool with the energy beam.

The sensor system may comprise a schlieren imaging system. The schlieren imaging system may comprise a knife edge arranged to block a proportion of the light focused by optics of the schlieren imaging system from reaching an imaging sensor, wherein variations in refractive index of the plasma plume alters the proportion of light blocked by the knife edge. Alternatively, the schlieren imaging may comprise a camera and a processor arranged to generate a schlieren image from images generated by the camera using a background-oriented schlieren technique.

The apparatus may comprise a processing chamber in which the melting process is carried out. A wall of the processing chamber that provides a background to an image of the plasma plume captured by the sensor system may comprise sufficient features to be suitable for use in background-oriented schlieren imaging. Typical sheet metal walls of processing chambers may not provide a background suitable for use in background-oriented schlieren imaging.

The irradiation device may be arranged to simultaneously direct a plurality of energy beams to a powder bed or substrate to form a plurality of melt pools. The sensor system may comprise a plurality of sensors, each sensor arranged to measure variations in a refractive index of a plasma plume generated during formation of a or the plurality of melt pools. Each sensor may be located at a different angular position about an axis perpendicular to the melt pool surface, wherein an angle between the angular positions is at least 90°.

The apparatus may be an additive manufacturing apparatus, in particular a powder bed fusion apparatus in which an object is built in a layer-by-layer manner by solidifying layers of powder.

The apparatus may comprise a computer analyser according to the fourth aspect of the invention.

According to a seventh aspect of the invention there is provided an energy beam melting process comprising directing an energy beam to a powder bed or substrate to melt the powder or substrate and measuring variations in a refractive index of a plasma plume generated during formation of a melt pool with the energy beam.

Measuring variations in the refractive index of the plasma plume may comprise schlieren imaging. The schlieren imaging may comprise blocking a proportion of the light focused by optics of an imaging system from reaching an imaging sensor with a knife edge such that variations in refractive index of the plasma plume alters the proportion of light blocked by the knife edge. Alternatively, the schlieren imaging may comprise a background-oriented schlieren imaging.

The melting process may comprise simultaneously directing a plurality of energy beams to a powder bed or substrate to form a plurality of melt pools. The melting process may comprise measuring variations in a refractive index of a plasma plume generated during formation of a or the plurality of melt pools with at least one of a plurality of sensors of the sensing system. Each sensor may be located at a different angular position about an axis perpendicular to the melt pool surface, wherein an angle between the angular positions is at least 90°.

The melting process may comprise an additive manufacturing process, in particular a powder bed fusion process in which an object is built in a layer-by-layer manner by solidifying layers of powder.

The melting process may comprise carrying out the monitoring method of the first aspect, second aspect and/or third aspect of the invention.

### DESCRIPTION OF THE DRAWINGS

FIG. 1 is a schematic of an apparatus for carrying out a melting process according to an embodiment of the invention;

FIG. 2 is a flowchart illustrating the processing carried out by a computer analyser according to an embodiment of the invention;

FIG. 3 is an overview of simultaneous optical and x-ray experimental setup;

FIG. 4 shows a composite image of X-ray and schlieren imaging of a sample;

FIGS. 5a to 5h show the time evolution of depression and plume under a stationary laser spot of power P=72 W and 1/e² diameter d=84 μm, corresponding to a power density of Φ=4P/πd²=1.3 MW/cm² for substrate only (no powder). FIGS. 5a, 5c, 5e and 5g are the schlieren images of the plasma plume and FIGS. 5b, 5d, 5f and 5h are the X-ray images of the melt pool;

FIGS. 6a to 6d are difference images due to laminar plasma plume (FIG. 6a) and steady melt pool (FIG. 6b) and a stage III keyhole (FIG. 6d) and corresponding plasma plume (FIG. 6c);

FIG. 7 is a plot of the total (summed) difference between each time step for both the plasma plume (schlieren imaging data) and the melt pool (X-ray imaging data);

FIG. 8 is a plot of measured surface depression depth from the X-ray images at each time step;

FIGS. 9a to 9d are images of a Ti-6Al-4V substrate and Argon atmosphere during scanning of single lines with varying scan speed and laser flux;

FIG. 10 is a plot of a normalised average difference between consecutive frames for varying input energy.

FIG. 11 is a log-linear plot of keyhole area variance;

FIGS. 12a-12c show measurements of depression morphology during laser line scanning with varying input energy, (a) is a graph of measured depression depth for experiments on substrate only and with a powder layer, (b) is a graph of measured front wall angle and (c) a graph of calculated drill rate based on experimental depth;

FIGS. 13a and 13b are composite images of keyhole and plume (a) without and (b) with powder under 3.7 MW/cm2 laser power density (P=204 W and d=84 μm);

FIG. 14 is a plot of keyhole depth with time with no powder and with a 100 μm layer of powder;

FIGS. 15a-15c are composite images of keyhole and plume (a) without and (b-c) with powder under 1.3 MW/cm2 laser power density (P=72 W and d=84 μm); and

FIGS. 16a to 16m are comparison of images of line scans with powder and without powder at varying input energy. a-f show X-ray images, showing that regardless of energy, melting powder on top of the substrate does not produce large differences in the melt pool, as the laser beam interacts mainly with molten material. g-m schlieren images for the same input energy reveal that the atmospheric flow arising from the imaged melt pools is not greatly influenced by powder.

### DESCRIPTION OF EMBODIMENTS

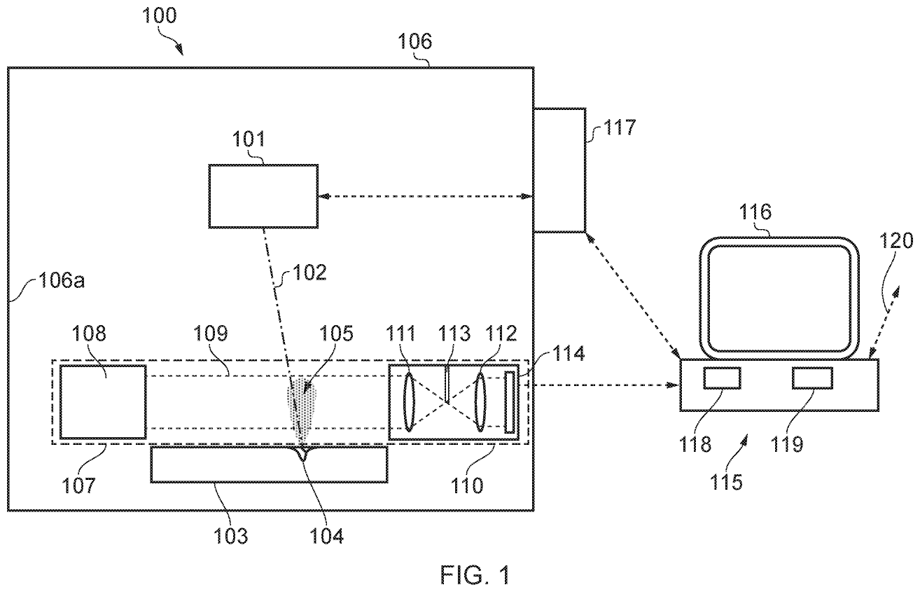

Referring to FIG. 1, energy beam melting apparatus 100 according to an embodiment of the invention comprises an irradiation device, such as a scanner 101, for directing an energy beam, in this embodiment a laser beam 102, to a powder bed or substrate 103 to melt the powder or substrate. The scanner 101 may comprise at least one transducer arranged to measure positions of at least one movable guiding element, such as a movable optical element, for steering the laser beam, such as described in WO2018/087556, which is incorporated herein in its entirety by reference. In this embodiment, the powder or substrate is made of metal material.

Formation of the melt pool 104 generates a plasma plume 105. The apparatus comprises a chamber 106 in which the melting process is carried out. Means is provided for providing a protective atmosphere, such as an argon or nitrogen atmosphere, in the chamber 106. A gas flow (not shown) may be generated across the powder bed or substrate 103 from a gas nozzle to a gas exhaust to carry away condensate generated by the melting process. The irradiation device 101 may be located outside of the chamber 106 and deliver the laser beam to the powder bed or substrate 103 through a window.

In one embodiment, the laser melting apparatus is a powder bed fusion apparatus, such as Renishaw's RenAM 500 Q powder bed fusion apparatus.

In addition, an apparatus according to the invention comprises a sensor system 107 arranged to measure variations in a refractive index of the plasma plume 105 generated during formation of the melt pool 104 with the energy beam 102. In this embodiment, the sensing system is a schlieren sensing system 107, which periodically generates schlieren images of the plasma plume 105. The schlieren sensing system 107 of this embodiment comprises an illuminating source 108, such as a light source and collimator, for generating a collimated, illuminating beam 109 directed across the powder bed or substrate to a detector 110. The detector 110 comprises a converging lens 111, which focusses the received light to a focal point. At least one knife edge 113 is provided at the focal point and is arranged to block a proportion of the beam from reaching a collimating lens 112 and imaging sensor 114, such as CCD or CMOS detector. The imaging sensor 114 is arranged to capture images at regular intervals.

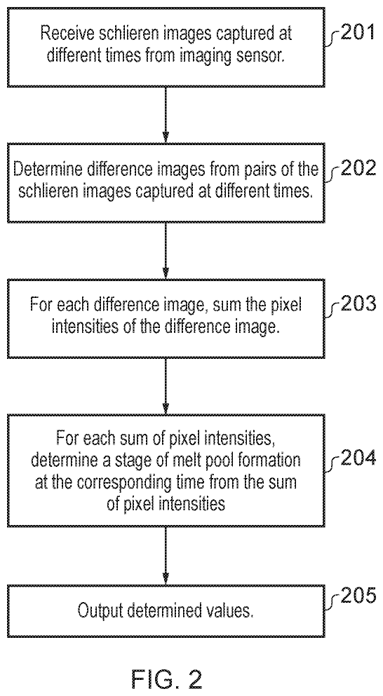

Images generated by the imaging sensor 114 are sent to analyser 115. In this embodiment, analyser 115 is a computer comprising a processor 118 and memory 119 having a programme stored thereon, which, when executed by the processor 118 causes the computer to carry out the analysis method as described below with reference to FIG. 2. The analyser 115 may be an integrated part of the apparatus 100 or may be located at a remote location from apparatus 100. The communication with analyser 115 may be over a network, such as the Internet. The analyser 115 may be connected with multiple energy beam melting apparatus 100 as indicated by arrow 120.

In further embodiments, the irradiation device 101 is arranged to direct a plurality of energy beams, such as a plurality of laser beams, to the powder bed or substrate 103. In such an embodiment, image processing software may process the image to separate out individual images of each plasma plume generated by the plurality of energy beams and the analysis method described with refence to FIG. 2 may be carried out separately for the plasma plumes generated by each energy beam. The irradiation device 101 may comprise a plurality of scanners or optical trains, each for individually steering one of the energy beams to the powder bed or substrate 103.

The energy beam may be scanned across the powder bed or substrate 103 by steering elements, such as movable optical elements, in the irradiation device 101 and/or by moving the powder bed and/or substrate 103 using a drive mechanism.

The apparatus may comprise a plurality of schlieren sensing systems 107 arranged to view the plasma plume(s) generated above the powder bed or substrate 103 from different angles such that, if a plasma plume is obscured from one schlieren sensing system 107, the plasma plume is captured by another one of schlieren sensing systems 107.

In a further embodiment, rather than using a schlieren sensing system 107 comprising a knife edge 113, the schlieren sensing system may be a background-oriented schlieren sensing system. In such a background-oriented schlieren sensing system an illuminating source 108 opposite the detector 110 is not required, nor is the converging lens 111, knife edge 113 or collimating lens 112. The background-oriented schlieren sensing system is arranged such that both the background (in this case sidewall 106a of chamber 106) and the plasma plume are in focus and distortion due to changes in refractive index of the atmosphere between the wall 106a and detector caused by the presence of the plasma plume are detected from consequential shifts in the image of wall 106a. In such an embodiment, the sidewall 106a is arranged to provide a suitable background for background-oriented schlieren, such as a two-dimensional pattern of contrasting areas. In accordance with the invention, the background oriented schlieren images are processed using the analysis method described with reference to FIG. 2.

Now referring to FIG. 2, a process stability of the melting process is quantified by comparing schlieren images obtained at different times and quantifying the change between the images. The computer analyser 115 receives 201 schlieren images captured at different times from the detector 110.

Images of the intensity difference between one schlieren image and the previous schlieren image are determined 202 in which each pixel takes the value pᵢ defined as p_{(i,k)}=(X_{(i,k)}−X_{(i-1,k)})², where Xᵢ is the intensity value of the k-th pixel in the i-th frame of the sequence. A summed difference Σp for each timestep is determined 203 by summing all pixels of the difference image for that timestep. The summed difference is a measure of turbulence in the plasma plume in that timestep. The summed difference for each timestep is then compared 204 to one or more difference thresholds to determine a stage in melt pool formation for that timestep. In particular, an amount of turbulence in the plasma plume, and therefore a value for the summed difference, is believed to correlate with a stage of melt pool formation. Accordingly, one or more difference thresholds can be used to demarcate the transition of the melt pool between different stages of melt pool formation. In this embodiment, a difference threshold is set to identify whether the stage of melt pool formation is either i) stable melting and the formation of the initial surface depression (stage I) or its transition into a metastable keyhole (stage II), or ii) an unstable keyhole (stage III). The threshold at which this happens can be determined empirically. In one embodiment, the threshold corresponds to the melt pool having a front wall angle of 70°.

The determined values are output in step 205. The output values could be the determined stages of melt pool formation, the summed differences and/or the difference images for each timestep.

In a further embodiment of the analysis method, the analyser 115 does not determine the stage of melt pool formation, outputting the summed difference for later analysis or display. For example, control of the melting process or a further melting process may be based on maintaining the summed difference within a defined processing window regardless of whether this corresponds to a standard categorisation of stages of melt pool formation. Furthermore, other statistical processing methods may be used to determine a measure of turbulence from the schlieren images. For example, image processing may be used that analyses schlieren images captured at different times without determining a difference image between the schlieren images. It may even be possible to determine a measure of turbulence in the plasma plume from images of the plasma plume that are not schlieren images.

The output from the analysis may be displayed on a display 116. For example, the determined stage of melt pool formation or measure of turbulence may be displayed as a two- or three-dimensional representation based on the location of the melt pool that generated the plasma plume on the part being manufactured. An operator/user may then use the two- or three-dimensional representation to identify regions of the part that may have been formed outside of a desired processing window. The location may be obtained from demand positions sent to a scanner during the corresponding timestep or measured positions of steering elements determined using the transducer(s) of the scanner 101 during the timestep. Alternatively, the output may be displayed as a time-series.

The output may be sent to a machine controller 117 for controlling the energy beam melting apparatus 100. The machine controller 117 may control the operation of the energy beam melting apparatus 100 in response to the output from the analyser 115. For example, the machine controller may control the energy beam melting apparatus to alter the exposure parameters of the energy beam when melting the powder bed or substrate 103. The exposure parameters may be a power of the energy beam, energy beam spot size, an exposure time, a point distance, a scan speed and/or a hatch spacing. The machine controller may control the energy beam melting apparatus to maintain the determined turbulence within a required range and/or to maintain melt pool formation in a desired stage, such as stage I and stage II.

Rather than the machine controller 117 determining any change that should be made to the control of the energy beam melting apparatus, the analyser 115 may make such a determination and the analyser may send a modified set of exposure parameters to the machine controller 117. In an alternative embodiment, rather than altering the current melting process, the analyser 115 may determine modified exposure parameters to use in a future melting process to be carried out by the energy beam melting apparatus or like apparatus. The future melting process may be the manufacture of a nominally identical part. For example, divergencies of the laser melting process from a desired processing window may be specific to the part geometry. Accordingly, an alteration to the exposure parameters made to maintain the melting process within the required operating window may only apply to parts of that geometry. The modification of the exposure parameters for manufacture of a part may be carried out in an iterative manner with each build resulting in new sets of exposure parameters generated by the analyser 115.

The control of apparatus 100 may be to halt the laser melting process if the measure of turbulence and/or stage of melt pool formation falls outside the desired value(s).

The analyser 115 may generate an alert if the measure of turbulence and/or stage of melt pool formation falls outside the desired value(s). The alert could be displayed on display 116, on a display on the energy beam melting apparatus 100 and/or sent to a remote device over data connection 120.

### Example 1

Simultaneous schlieren and X-ray transmission imaging of a melt pool formation was carried out enabling visualisation of the interaction between all phases of matter in laser powder bed fusion (LPBF) at the same time. The high magnification schlieren enabled direct imaging of the vapour jet emerging from the melt pool depression. It was found that the onset of capillary instability within the keyhole causes a transition from laminar to turbulent flow in the plasma plume. This transition causes refractive index changes in the atmosphere, that are measurable even if x-ray imaging is not available. Through systematic image analysis a threshold input energy was identified for the onset of this instability in Ti-6Al-4V alloy. It was found that introducing powder increases the keyhole stability and slightly raises the threshold input energy.

The experiments were carried out at the 32-ID-B beamline of the Advanced Photon Source (APS) at Argonne National Laboratory, USA. To simultaneously image all three phases during LPBF of Ti-6Al-4V, transmission x-ray imaging was complemented by schlieren imaging.

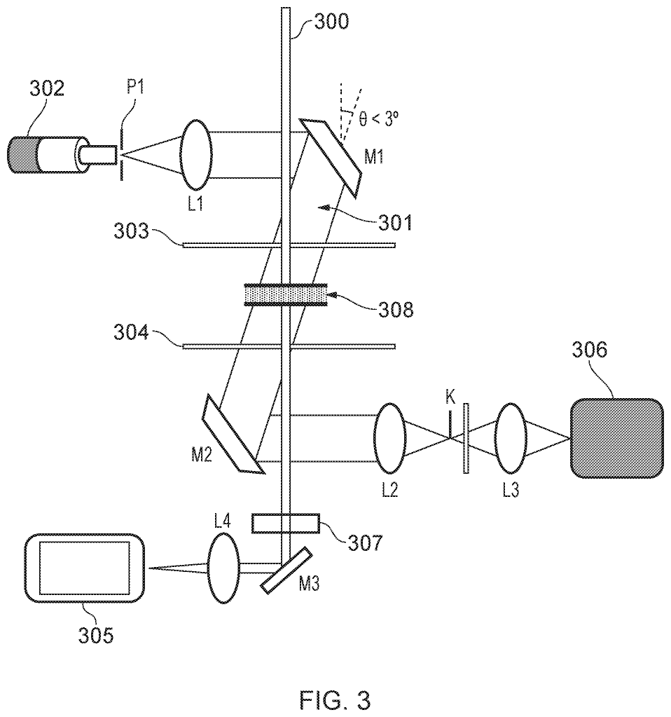

As shown in FIG. 3, 2.4 keV synchrotron X-rays 300 passed through ˜400 μm thick Ti-6Al-4V samples 308, held in place by glassy carbon slides inside the LPBF process simulator. The motion of the vapour and airborne particles in the Argon atmosphere were visualised by schlieren imaging via pickoff mirrors, M1 and M2 that folded the optical beam 301, generated by LED 302 and 150 μm pinhole P1, at a ˜2° angle to the X-ray beam, resulting in a nearly co-axial view of the process. The LED emitted light having wavelengths in the range of 400-700 nm.

L1 is a SMC Pentax-A 50 mm f/1.5 lens, L2 is Sigma DL 75-300 mm lens and L3 is Sigma 150-600 mm f.5-6.3 lens. The knife edge, K, was set to block 50% of incoming light, evenly measuring ∂n/∂x gradients. Low-pass filtering (Schott KG-5 glass) blocked excess process light. A Lu3Al5O12 scintillator 307 converted the X-ray signal to 535 nm light. L4 is a 10× Objective lens (N.A. 0.28).

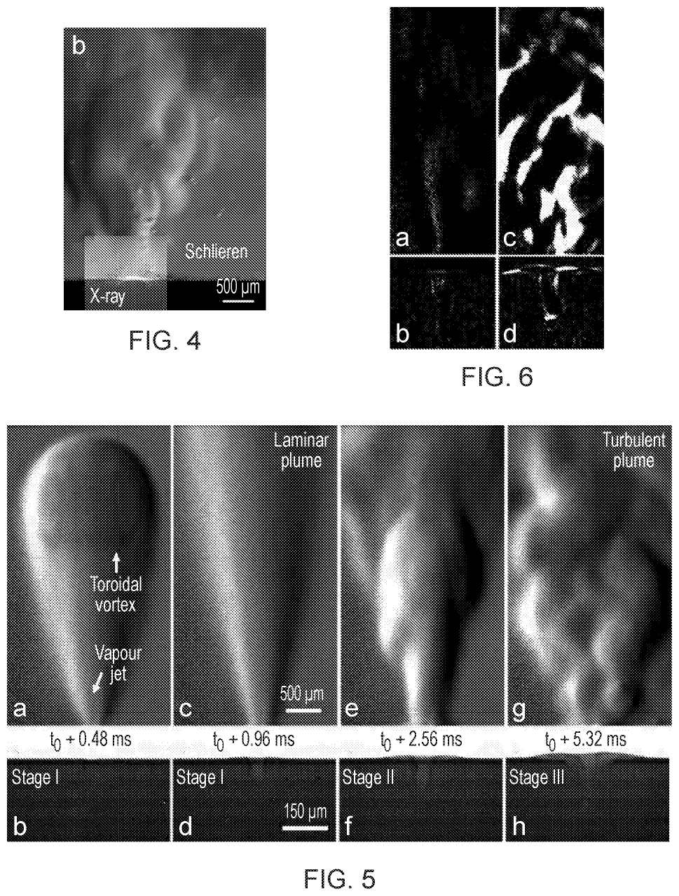

FIG. 4 shows a composite image comprising superimposed x-ray and schlieren images of the Ti-6Al-4V sample and ˜100 μm height powder layer processed in an Argon atmosphere within the LPBF simulator.

FIGS. 5a to 5h shows the evolution of a surface depression and associated vapour jet and plume under stationary laser illumination for power density Φ=1.3 MW/cm². Initially, the surface under the laser spot rapidly heats up close to the boiling point and the vapour pressure of each constituent increases, resulting in a steady jet of Al, V and Ti vapours. FIG. 5a shows the propagation of this flow in the Argon atmosphere as it entrains the surrounding gas, forming a characteristic laser plume. Refractive index gradients outline the interface between the plume and the atmosphere, which are proportional to density gradients in the fluid. These density gradients are in turn due to the underlying pressure and temperature fields, in addition to the concentration of the evaporated species. The schlieren features appear darker or lighter than the background, indicating a change in sign of the gradient. At the bottom of the image, between the positive and negative refractive index gradients, the vapour jet can be discerned at the core of the plume. As the hot metallic vapour ejected from the liquid-vapour interface cools, nanoparticles form via nucleation and condensation, growing in size through processes such as continuous oxidation, coagulation and agglomeration as they propagate upwards. At the top interface between the ambient medium and the plume, viscous stresses cause the fluid to turn outwards, resulting in the formation of a toroidal vortex. Here, a high concentration of nanoparticles (i.e., fumes) blocks the incident broadband light, producing the dark line that trace the fluid motion within the plume's cap. FIG. 5b shows the corresponding X-ray image for that time instant; only a slight surface depression has been formed on the molten volume due to the recoil of the vapour pressure. It is interesting to note that a substantial plume is present prior to any significant surface depression, owing to the high speed of the vapour jet of the order of hundreds of m/s. The vapour jet dissipates, entraining the surrounding Argon atmosphere to create a plume that rises due to the net accumulated momentum

FIG. 5a shows an initial plume front propagating upwards in Argon atmosphere due to vapour jet. Metallic fumes follow the flow's streamlines, outlining a vortex structure at the tip of the plume. FIG. 5b shows the initial depression (depth˜5 μm). FIG. 5c shows expansion of the evaporated species leads to a steady atmospheric flow. FIG. 5d shows depression depth steadily increases (depth˜25 μm). FIG. 5e shows the momentum driving the laminar flow changes direction according to the motion of the vapour jet, intermittently disrupting the laminar flow pattern. FIG. 5f shows the depression expands rapidly, while the previous hemispherical shape is maintained (depth˜120 μm). FIG. 5g shows turbulent plume comprised of several eddies formed by constant fluctuation of the liquid-vapour interphase. FIG. 5h shows a fully evolved keyhole, driven by capillary instability.

After a further 0.48 ms of laser irradiation, the surface depression continues to deepen (FIG. 5d). Its depth progression is gradual with a parabolic shape because of the vapour's pressure distribution across the surface. The jet of evaporated species emitted from that surface is in turn stable, and therefore the atmospheric flow appears laminar (FIG. 5c); this stable plume expands as it propagates upwards. Over time, as the surface depression deepens (FIG. 5f), oscillations in the liquid-vapour interphase mark the transition to a keyhole. The vapour emitting surface of the keyhole is perturbed, changing the direction of the vapour jet and plume (FIG. 5e). Sudden changes in the keyhole shape correspond to more pronounced fluctuations of the flow structure.

The intensity of the density gradients of 5e is noticeably higher compared to previous frames: the background intensity remains unchanged compared to previous frames, indicating that the temperature and concentration of the vapours has increased. This observation is consistent with measurements of increased laser absorption as the depression depth increases and calculations of high temperature regions on the keyhole walls as the laser drills into the material.

FIG. 5h shows a fully formed keyhole, the surface of which is constantly fluctuating according to the interactions of vapour pressure, surface tension, gravity, drag from the vapour flow, and accumulated momentum within the liquid metal volume. As a result, the plume is disrupted completely (FIG. 5g), and a more chaotic, turbulent flow is observable. Despite this instability, momentum is still predominately directed upwards, but the flow (and fume distribution) is more diffuse due to the formation of eddies.

FIG. 5 indicates that the dynamic melt pool behaviour can be divided into three stages, corresponding to the stable formation and growth of the surface depression and laser plume (stage I), which transitions into a metastable state where the liquid-vapour interface is perturbed but its shape recovers (stage II) and ultimately, unstable melting and plume due to a continuously fluctuating keyhole (stage III). The terms conduction, transition, and keyhole regimes, which are often used to characterise ex-situ micrographs of the melt pool in both laser welding and LPBF have been avoided because they can be misleading for these in-situ keyhole and laser plume measurements. A conduction mode melt pool contains a stable ‘keyhole’ depression even for power densities much lower than those typically used in LPBF. As the power density increases, the stable depression increases in depth to produce a transition mode melt pool that is elongated in the depth direction, and eventually an even deeper keyhole mode melt pool, although there is no single measure where that begins. There is likely to be some overlap in power density range between stage II describing the onset of keyhole and laser plume instability and the regime for a transition mode melt pool cross-section, but there is no expectation or requirement that these qualitative descriptions of different aspects of the process correspond exactly.

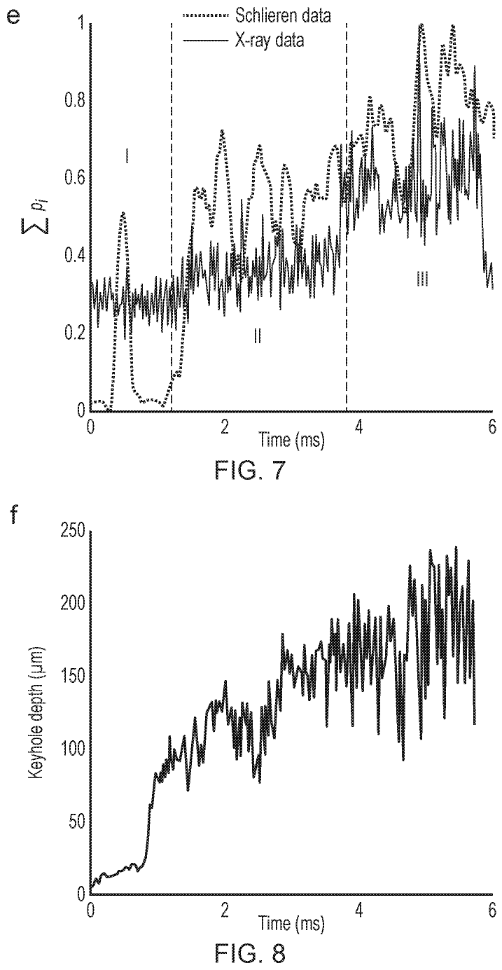

The evolution of the keyhole was examined by measuring the depression depth in the x-ray images, as well as the average intensity difference between consecutive images in both the x-ray and schlieren datasets (FIGS. 7 and 8). The continuous increase in variability is indicative of the melt pool's progression towards instability over time. The stages of the melt pool can be distinguished, as turbulence levels in the plume register distinctly, matched by the increased keyhole oscillations. The strong coupling of the liquid and vapour phases is thus evident in the synchronisation between periods of stability and instability. The isolated peak in stage I for the schlieren data in FIG. 7 is due to the initial establishing of the laser plume seen in FIG. 5a. Under a stationary laser, the melt pool will always undergo these stages, provided that the laser power density is sufficiently high; naturally, the time required for the keyhole to form and eventually become unstable is dependent on the total energy input.

Stages I-III of keyhole evolution are discernible in both datasets, owing to the strong coupling of liquid-vapour phenomena. The keyhole depth increases gradually during stage I, with a rapid drilling marking the transition to stage II. The penetration fluctuates increasingly over time, due to keyhole instabilities. FIG. 7 shows, for both datasets, the total change in each frame increases over time as the system tends towards instability.

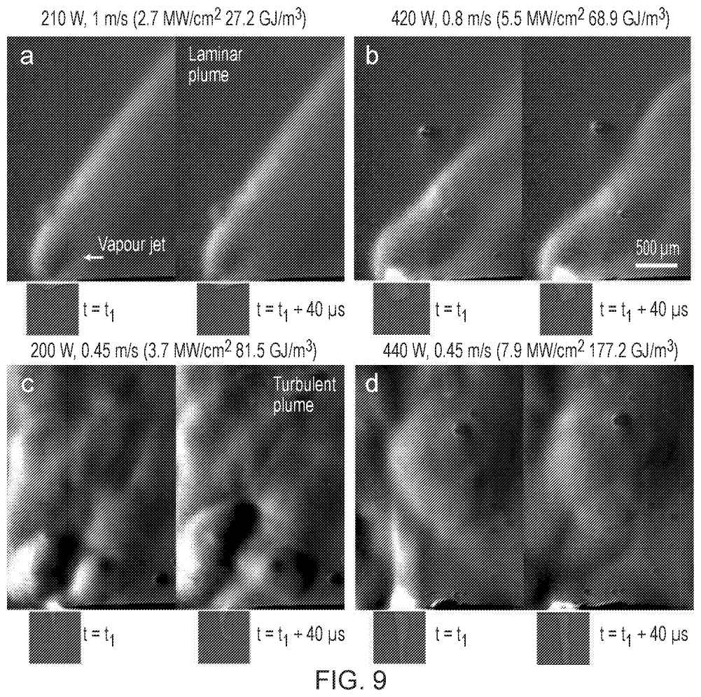

Scanning the laser beam introduces additional dissipation of the laser energy and changes the momentum balance in the melt pool, which affects the stability of the melt pool. Simultaneous imaging was carried out for line scans on the substrate without powder for varying power density and scan speed (FIG. 9). For each power, the figure shows two consecutive frames captured at time t1 and t1+40 μs, where the melt pool has reached a steady state after a scan length of ˜2 mm, in order to demonstrate the relative stability of the keyhole depression and laser plume in each case. The figure also indicates the linear input energy density for each laser line scan, defined as E=4P/νπd²=Φ/ν, where v is the laser scan speed and Φ is the previously-defined power density. It is shown that this input energy can be used as a meaningful metric for LPBF, which does not typically use the high-velocity or high-power regimes where their effects may decouple. It is worth emphasizing that, despite the common units of J/m3, this is not a volumetric energy density typically defined using the hatch spacing or powder layer thickness.

### Example 2

Visualisation of the Ti-6Al-4V substrate only (no powder) and Argon atmosphere during scanning of single lines with varying power input energies. The outline of the keyhole boundary is highlighted in red in the x-ray images, which are at the same scale as the schlieren image. FIG. 9a shows, under low energy input, the depression's shape remains constant and a steady vapour jet emitted from the irradiated surface results in a laminar plume. FIG. 9b shows, for E<70 GJ/m3 the depression remains at stage II, where small fluctuations in the liquid-vapour interphase perturb the plume but the flow pattern remains. FIGS. 9c-d show high input energy due to (c) low scanning speed or (d) high power density result in stage III depressions with turbulent plumes.

When the power is relatively low and the scan speed relatively high (FIG. 9a), the input energy, E˜27 GJ/m³, is dissipated fast enough that the melt pool remains at stage I; the surface depression is shallow, while its shape remains constant. The vapour jet is visibly established perpendicular to the irradiated surface, which is mainly the front wall of the depression. Owing to the invariance of the liquid-vapour interface, the jet's angle and induced atmospheric flow remain constant over time.

As the input energy increases to E=˜69 GJ/m³, the keyhole is deeper and wider but retains its shape, with periodic fluctuations of the rear wall (FIG. 9b). The depression is only perturbed weakly; thus, the plume's laminar flow structure is preserved. The melt pool evolves to stage II, where perturbations of the liquid-vapour interphase between the keyhole and laser plume are dampened by the scanning motion. Due to the higher laser power, a higher vapour content is observable within the plume and a bright region appears over the keyhole. This bright region is attributed to thermal radiation emitted by hot vapour and condensate (fume): reflections or scattering effects are ruled out because 1070 nm radiation was heavily filtered by the KG-5 glass.

In FIG. 9c, power is reduced by 33% but the scan speed is reduced by 45% compared to FIG. 9b, resulting in a total higher input energy E=˜82 GJ/m³. A stage III melt pool is observed in this case, with stronger oscillations and frequent collapses of the keyhole walls and several disjointed density gradients in the laser plume due to the complex vapour flow pattern emerging from the keyhole. Increasing the incident laser power density by a factor of ˜2.1 (FIG. 9d) resulted in an even more dynamic melt pool with a deeper, intensely oscillating keyhole. The white streak observable in the laser plume at t=t₁ is again attributed to thermal radiation, due to interaction of the incident laser beam with the fume.

Many experiments similar to FIG. 9 were conducted with combinations of laser powers and scan speeds in the range 203-442 W and 0.2-1.5 m/s respectively, for 1/e² beam diameters of 84 and 99 μm. Automated edge detection of the keyhole boundaries enabled its area to be calculated in every image. The average area and its standard deviation through all images in each sequence are plotted against the input energy in FIG. 11. The area measurements are indicative of the wide range of possible keyhole morphologies, with relatively large depressions forming even at low input energies. However, the rapid increase in standard deviation with input energy relates directly to the increased instability of the melt pool and of the liquid-vapour interphase. The degree of instability was again quantified from the intensity difference between consecutive images of the keyhole and laser plume, averaged through all the difference images in each sequence (Error! Reference source not found. 10). For the x-ray data, the average intensity difference increases linearly, showing that instability levels scale with input energy. However, for the schlieren data, the variability only increases linearly for experiments at E<70 GJ/m³ beyond which it undergoes a considerable increase and is no longer related to the input energy. Experiments with E<70 GJ/m³ have a laminar plume and steady depressions, while turbulent flows with unsteady depressions were observed when that energy was exceeded.

The definition of input energy we use enables a greatly simplified approach to predict the depression size and provides a physical basis for the threshold in keyhole stability observed at 70 GJ/m³. It has been shown previously that the depression penetration depth, D, scales linearly with laser power, but a separate gradient was obtained at each combination of scan speed and beam diameter. A geometrical model relating this penetration to the angle of the front wall of the keyhole, θ, has also been validated. In that model, tan θ=D/d=ν_{drill}/ν, where v_{drill} is rate at which a stationary laser spot drills into the material. Plotting the front wall angle against power density again produced a separate line for each combination of scan speed and beam diameter. Hence it is difficult to use this information for parameter selection, or to explain melt pool regime change across the parameter space.

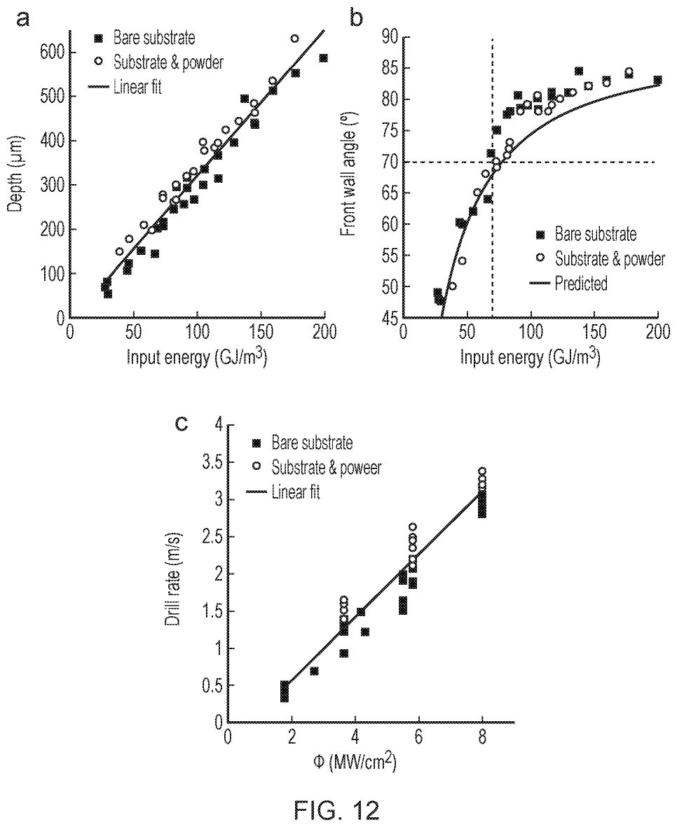

The keyhole depth and front wall angle were measured in the x-ray images and are plotted against input energy (FIGS. 12a and 12b). The measured depth was used to calculate the drill rate for the corresponding power density range (FIG. 12c). The straight lines represent a least square fit to the depth and drill rate (FIGS. 12a and 12c). Using the gradient of the fitted lines, the front wall angle at each energy density can be predicted: a least squares fit to those points is the line shown in FIG. 12b. Immediately it is seen that the input energy provides a single line for the depth and front wall angle across all the laser powers, scan speeds and beam diameters tested, which can now be used for process parameter selection.

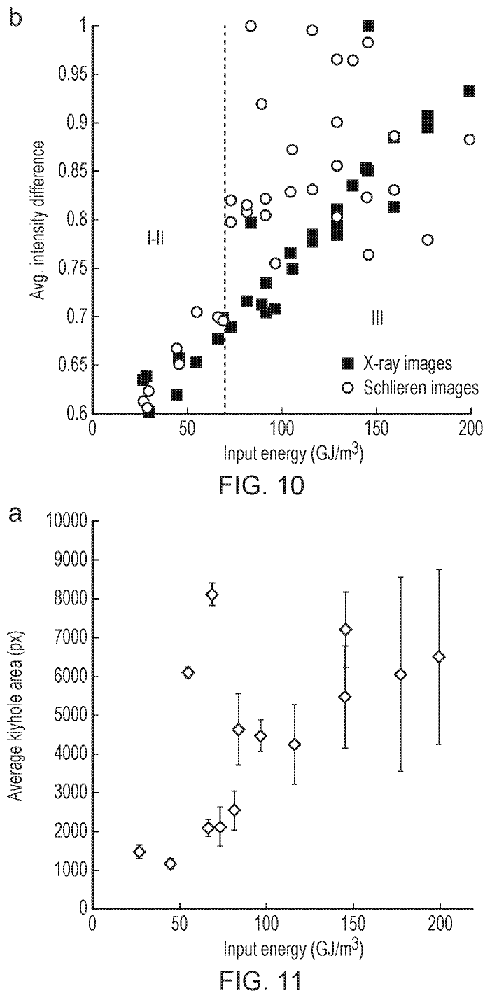

The depression depth scaled linearly with input energy, despite the increase in laser absorptivity associated with the transition to keyhole. This additional absorbed energy is seemingly offset by fluid dynamic effects in the melt pool, as shown by the increased standard deviation in the measured keyhole area (FIG. 11) and does not translate into a larger increase in penetration. We observe a steep increase in the depression's front wall angle close to E=˜70 GJ/m3, where the front wall angle approaches 70°. In light of the stability analysis (FIG. 10/FIG. 11), this rapid rise in front wall angle is characteristic of the transition to a stage III depression. This measurement validates recent numerical modelling of keyhole dynamics, showing an increase in inclination from 65° to 75° initiates the occurrence of multiple reflections within a scanning depression and that cause the complex thermocapillary phenomena responsible for unstable keyhole formation.

### Example 3

To visualise the interaction between the liquid-vapour interphase and solid particles, spot welds and scan lines were carried out using a ˜100 μm powder layer under varying energy input. In all experiments, the top surface of the powder layer was positioned at the same height as the top surface of the substrate only, in order to maintain a common reference plane for the calibrated laser spot diameter and the measured keyhole depth between the two cases.

Under a stationary laser power density of 3.7 MW/cm², the depression initially has the same drill rate regardless of the powder layer, transitioning to an unstable keyhole after ˜350 μs (FIG. 14). During the initial period, the intense drilling interaction rapidly melts, evaporates or ejects metal and particles alike. In both cases, the penetration depth fluctuated significantly over time, due to the hydrodynamic instabilities of the keyhole regime, resulting in the immediate formation of a turbulent phase. Powder particles were continuously entrained from the vicinity of the laser spot due to the induced atmospheric flow. A fraction of these particles was incorporated into the melt pool, while the rest were lifted off the powder bed. It is clear from the composite images that particles near the powder bed that entered the visualised plume area were ejected by lift forces from the jet. Lower penetration was consistently observed when powder was present. This reduction in penetration is attributed to a combination of two factors in the powder case: stronger oscillations on the upper part of the keyhole which did not allow multiple reflections to irradiate the same locations within the keyhole for extended periods of time, and powder particles periodically blocking incident light.

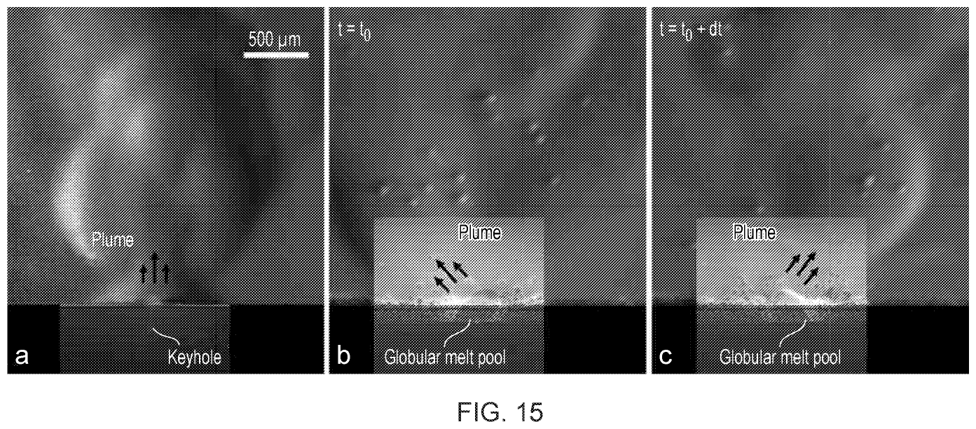

FIGS. 5 to 8 show that the laser power density of 1.3 MW/cm² resulted in a more gradual stage I-III transition, than for 3.7 MW/cm² (FIG. 14). The laser material interaction at his lower power density differed significantly from the substrate only (FIG. 15a) with the introduction of powder (FIG. 15b, 15c): powder particles were continuously consolidated in the melt pool without forming a keyhole, while a slower vapour jet ejected fewer particles, resulting in a large globular melt pool. The recoil pressure of the vapour jet caused a sideways motion of this molten volume. The composite image shows the plume establishes perpendicular to the surface at the exposed spot, indicating the direction in which the reaction force is applied onto the melt pool. The molten sphere and plume oscillated continuously while exposed to the laser; this motion enhanced powder denudation, resulting in the incorporation of more powder particles and increase in melt pool size over time.

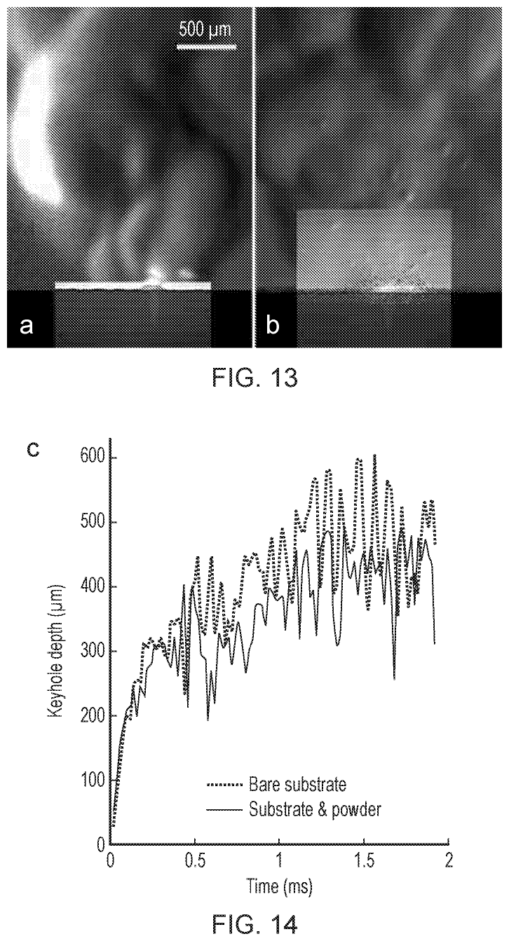

The introduction of powder prevents the evolution of the depression into a keyhole. Instead, a large melt pool is formed, with the vapour jet moving the surface depression, thus displacing the molten volume. The direction of the plume continuously shifts from left to right as the interplay of surface forces drive a periodic motion of the liquid metal. The refractive index gradients in the observed plume are weaker in all cases compared to FIG. 13 due to the lower concentration of evaporated material at this lower powder density.

The apparent instability can be explained by considering the forces acting on the surface of this globular melt pool. Where the laser is incident, the recoil pressure pushing the surface is in competition with the local Marangoni force and capillary pressure. When the vapour pressure is low, the downwards drill rate is comparable to the sideways motion of the liquid, resulting in a diagonal motion of the depression. The observed motion shows that upper part of the liquid-vapour interphase of a large semi-spherical molten mass is unstable, resulting in the movement of the liquid volume. It is hypothesized that when the volume deforms sufficiently, increased capillary pressure due to the steeper surface curvature acts as a restoring force, driving the oscillatory motion. Thus, the recoil pressure pushes the melt pool to one side, but growing surface and gravitational forces eventually overcome this pressure, causing the liquid metal to collapse. The accumulated momentum shifts the centre of gravity to the other side, and the cycle repeats. This oscillating instability was consistent across all experiments carried out with lower power, where the penetration depth in the bare plate did not rapidly exceed the depth of the powder layer. Whilst the particular motion of this globular melt pool under spot illumination is not directly applicable to the majority of L-PBF processes, the observed dynamics demonstrates that the total powder mass incorporated into a melt pool influences the depression's morphology, which, in turn, affects the stability of the L-PBF processes.

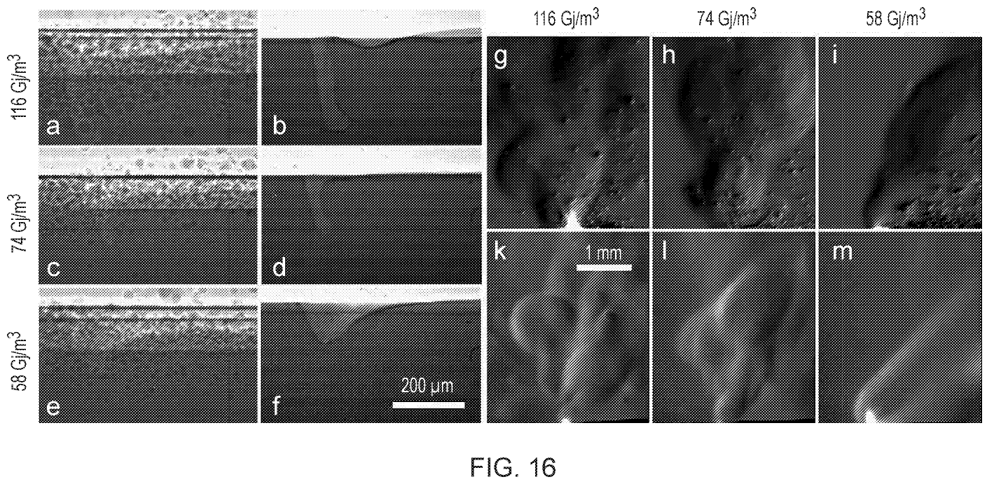

FIG. 16 is a comparison of images of line scans with powder and without powder at varying input energy. FIGS. 16a-f show that regardless of energy, melting powder on top of the substrate does not produce large differences in the surface depression, because the laser beam interacts mainly with molten material. FIGS. 16g-m reveal how the plume and atmospheric flow interacts with the powder layer.

FIG. 16 shows frames from line scans with input energies in the range 58-116 GJ/m³. The X-ray images show that powder particles are continuously incorporated into the melt pool due to translation of the laser beam.

The schlieren images reveal that in addition to guiding entrained particles towards the laser beam, the atmospheric flow induced by the vapour affects the local availability of powder. When the laser scan speed is low, the interaction time between the atmospheric flow and powder particles is longer; as a result, a larger fraction of nearby particles is ejected, increasing the amount of hot spatter (FIG. 16g). In addition, the turbulent flow and highly variable vapour jet result in a wide range of ejection angles for hot spatter. Conversely, a constant depression with a shorter interaction time results in airborne particles with more homogeneous trajectories (FIG. 16i).

The observed keyhole morphologies were qualitatively similar regardless of the presence of powder. The lower mass in the powder layer results in a consistently deeper penetration, compared to the substrate only, across the full range of line scan input energies

The Examples presented underline the interconnectivity between the evaporation dynamics, motion of liquid metal and particle behaviour in LPBF. It can be observed that the behaviour of the surface depression is mirrored in the motion of the vapour jet and plume, which implies that the stability of the system can be determined by interrogating either. It was shown that the transition of the melt pool from stable depression to keyhole is accompanied by a transition from laminar to turbulent flow in the accompanying plume. Moreover, an increased intensity of the observed refractive index gradients during this event suggested that the temperature and concentration of the emitted vapours was higher.

The intensity difference between consecutive frames was characteristic of the stability of the process, allowing identification of three distinct stages in the evolution of melt pools. The strong coupling of the vapour and liquid phases was evident this combined analysis. Image processing across multiple datasets quantify the degree of instability according to input energy. It was determined that for Ti-6Al-4V samples, the transition between stage II (stable) and stage III (unstable) depressions and thus laminar to turbulent plumes, occurred at an input energy of E˜70 GJ/m³.

No pores were detected for stage I/II melt pools because of the relative invariance of the liquid-vapour interface, i.e. a stable depression in the melt pool surface. Unstable, stage III keyholes are prone to collapse, resulting in excess porosity. Increased atmospheric turbulence at E>70 GJ/m³ identified that the melt pool had progressed to stage III, corroborated with the depression front wall angle reaching ˜70°. This results in porosity, as can be seen in the supporting materials, for the cases at 68 and 74 GJ/m³. In the powder case, where the instability threshold is slightly higher, the onset of porosity can be seen between 73 and 81 GJ/m³. The identified input energy stability threshold of 70 GJ/m³ may be an upper limit for L-PBF processing Ti-6Al-4V. The upper threshold input energy will be different for other materials and could be identified with schlieren imaging alone if access to x-ray imaging is not available. A corresponding lower input energy threshold may exist: as low energy input can cause hydrodynamic instabilities in the melt pool, resulting in balling or other inconsistencies in solidified tracks, which ultimately lead to lack of fusion defects. Instabilities of that type were observable near the solidification front, but the magnification and field of view of our experimental setup were tuned to probe liquid-vapour interactions for this study.

The introduction of powder did not result in significant differences in the observed keyhole morphology and atmospheric flow. Turbulent plumes due to unstable keyholes produced a wider spread in the trajectories of spattered particles, with generally higher velocities due to stronger atmospheric flows and thus, more frequent particle-jet interactions. Powder was found to have a mild stabilising effect with stage III keyholes observed for Ti-6Al-4V just above E=˜70 GJ/m³, confirming the validity identified threshold as a broad guide for parameter selection.

### Simultaneous Optical and X-Ray Imaging

Borosilicate glass windows were used in both sides of the processing chamber, replacing the Kapton windows that are typically used for x-ray imaging: attenuation of the optical beam was too large with Kapton, and its optical thickness is not sufficiently uniform for the requirements of schlieren imaging. The energy of the x-ray flux caused radiation-induced darkening of the glass windows, which attenuated the x-rays and required the exposure time of the camera to be increased, slightly degrading the contrast in the x-ray imaging. However, the darkened spot remained outside of the field of view of the schlieren system and did not affect optical transmissivity. The high-speed camera for x-ray imaging (Photron fastcam SA-Z) was setup at 50 kfps rate and 600×640 pixels field-of-view, whilst the camera for schlieren (Photron fastcam mini AX200) recorded at 25 kfps and 384×560 pixels resolution. The total magnification for the x-ray setup was four times larger than that of the schlieren system, resulting in approximately 1.2×1.3 mm² and 4.4×3 mm² fields of view, respectively.

### Image Processing for Display

All images were processed using MATLAB software, including the image processing toolbox add-on. 16-bit schlieren images from the Fastcam mini camera were initially converted to double precision arrays to facilitate the processing. To reduce the effect of background imperfections due to slight soiling and misalignment of the optics, each frame within the schlieren image sequence was divided by the initial frame, which contained no flow information. Following the division, it was observed that the brightest pixels had a value˜3, while the darkest ones were close to 0. Multiplication with a constant (in this case, 85) allowed restoration of the DC grey levels removed by the division, before direct encoding to 8-bit unsigned integers (0-255 value range). Finally, the contrast of the resulting 8-bit images was stretched by margins fixed across datasets, so that ˜2% of pixels were saturated. Background removal was not necessary to adequately display the x-ray images. Thus, images were imported to MATLAB directly as 16-bit, contrast stretched to saturate ˜2% of pixels (fixed margins across datasets) and converted to 8-bit.

Videos of each processed image sequence were produced in MATLAB. Composite videos were produced by importing the individual videos into OpenShot video editor software. The schlieren videos were upscaled by a factor of 2, while the X-ray videos were downscaled by a factor of 0.5. In the overlaid region, an x-ray/schlieren intensity ratio of 0.6 was found to yield the best result.

### Image Differencing

The advantage of this approach is that both schlieren and x-ray datasets were evaluated using a common metric. Images of the intensity difference between one frame and the previous were produced, in which each pixel takes the value pᵢ defined as p_{i,k}=(X_{i,k}−X_{i-1,k})², where Xᵢ is the intensity value of the k-th pixel in the i-th frame of the sequence. For spot illumination, the total difference Σp in each timestep, simply taken as the sum of all pixels of every frame and normalised by division with the maximum value in the dataset, was used in FIG. 7. For line scan illumination, to reduce the information for the entire image sequence to a single point Σ̅p̅, the total difference of every frame in the sequence was summed and divided by the total number of frames, as plotted in FIG. 10.

### Keyhole Boundary Detection

Initially, 16-bit x-ray images were cropped to only include the upper ˜200 μm of substrate. Background removal by division, direct conversion to uint8 and contrast stretching followed, as outlined above. To reduce noise, images were filtered by convolution with a 2-D Gaussian kernel with a standard deviation of 3, in addition to median filtering with a 7×7 pixel kernel. The filtered images were then binarised based on a global threshold. Interestingly, trial and error with 2-3 different values for the binarisation threshold (0.48-0.5 in this case) produced better results than more sophisticated adaptive threshold techniques, such as Otsu's method. The edges of the binary image were then detected using the Sobel edge detection method. For some frames, small imperfections in the substrate or camera noise would remain above the binarisation threshold and therefore register as distinct edges. This was corrected by counting the number of pixels within each detected area and considering only the one with highest total. The detected edge was then overlaid onto the original image for display. The standard deviation of the detected area was calculated as σ=\sqrt{(A−μ)²/(N−1)}, where A is the keyhole area in each frame, and μ is the mean area over N analysed frames.

It will be understood that modifications and alterations can be made to the above described embodiments without departing from the invention as defined herein.

1. A monitoring method for monitoring a melting process comprising receiving sensor values captured with a sensor system measuring a property of a plasma plume generated during formation of a melt pool with an energy beam; and determining a measure of turbulence in the plasma plume from the sensor values.

2. A monitoring method according to claim 1, comprising determining a melt pool formation stage from whether the measure of turbulence is above or below a threshold value.

3. A monitoring method according to claim 1, comprising determining from the measure of turbulence a melt pool morphology, wherein determining a melt pool morphology may comprise determining from the measure of turbulence whether the melt pool has a ratio of depth to width of greater or less than 1.5.

4. A monitoring method according to claim 1, comprising determining the measure of turbulence from sensor values captured at different times during melt pool formation, and the method may further comprise determining the measure of turbulence from a difference in the sensor values captured at the different times.

5. A monitoring method according to claim 1, wherein the sensor system comprises an imaging sensor and the sensor values are images of the plasma plume, wherein the measure of turbulence is determined from image processing, wherein the measure of turbulence may be determined from an intensity difference in pixel values of images captured of the plasma plume at the different times, and the measure of turbulence may be determined by summing the differences in corresponding pixels of images captured at the different times.

6. A monitoring method according to claim 1, wherein the property measured by the sensor system is variations in refractive index of the plasma plume.

7. A monitoring method according to claim 6, wherein the sensor values are images representing variations in refractive index within the plasma plume caused by density gradients within the plasma, wherein the images of the plasma plume may be captured using schlieren imaging.

8. A monitoring method according to claim 1, comprising receiving sets of sensor values captured with a plurality of sensors of the sensor system, each sensor measuring a property of the plasma plume generated with the energy beam and each set of sensor values captured by a different one of the sensors, and determining from at least one of the sets of sensor values a measure of turbulence in the plasma plume and/or the difference in the refractive index measured at the different times.

9. A monitoring method according to claim 1, comprising determining from the measure of turbulence whether melt pool formation occurred in either i) one of stage I (conduction mode) and stage II (transition mode), or ii) stage III (keyhole mode).

10. A monitoring method according to claim 1, comprising carrying of an action in response to the measure of turbulence.

11. A monitoring method according to claim 1, wherein the method is carried out by a processing unit of a computer.

12. A computer analyser arranged to carry out the monitoring method of claim 1.

13. A data carrier having instructions stored thereon, the instructions, when executed by a processor causing the processor to carry out the monitoring method of claim 1.

14. A monitoring method for monitoring a melting process comprising receiving sensor values captured with a sensor system measuring a refractive index of a plasma plume generated during formation of a melt pool with an energy beam, the sensor values captured at different times during melt pool formation; and determining a difference in the refractive index measured at the different times from the sensor values.

15. A monitoring method according to claim 14, wherein the sensor values are images representing variations in refractive index within the plasma plume caused by density gradients within the plasma, wherein the images of the plasma plume may be captured using schlieren imaging.

16. A monitoring method according to claim 14, comprising receiving sets of sensor values captured with a plurality of sensors of the sensor system, each sensor measuring a property of the plasma plume generated with the energy beam and each set of sensor values captured by a different one of the sensors, and determining from at least one of the sets of sensor values a measure of turbulence in the plasma plume and/or the difference in the refractive index measured at the different times.

17. A monitoring method according to claim 16, comprising determining from the measure of turbulence whether melt pool formation occurred in either i) one of stage I (conduction mode) and stage II (transition mode), or ii) stage III (keyhole mode).

18. A monitoring method according to claim 14, wherein the method is carried out by a processing unit of a computer.

19. A computer analyser arranged to carry out the monitoring method of claim 14.

20. A data carrier having instructions stored thereon, the instructions, when executed by a processor causing the processor to carry out the monitoring method of claim 14.

21. A monitoring method for monitoring a melting process comprising receiving a measure of turbulence in a plasma plume generated during formation of a melt pool with an energy beam; and determining from the measure of turbulence whether melt pool formation occurred in either i) one of stage I (conduction mode) and stage II (transition mode), or ii) stage III (keyhole mode).

22. A monitoring method according to claim 21, comprising carrying of an action in response to the determined stage of melt pool formation.

23. A monitoring method according to claim 21, wherein the method is carried out by a processing unit of a computer.

24. A computer analyser arranged to carry out the monitoring method of claim 21.

25. A data carrier having instructions stored thereon, the instructions, when executed by a processor causing the processor to carry out the monitoring method of claim 21.
